(19) United States
(12) Patent Application Publication
(10) Pub. No.: US 2012/0224203 A1
(43) Pub. Date: Sep. 6, 2012

(54) PRINTING APPARATUS, METHOD OF PREVENTING REMOVAL OF DOCUMENT FROM BEING FORGOTTEN, AND PROGRAM

(75) Inventor: Sadahiro Masuda, Shizuoka (JP)

(73) Assignees: TOSHIBA TEC KABUSHIKI KAISHA, Tokyo (JP); KABUSHIKI KAISHA TOSHIBA, Tokyo (JP)

(21) Appl. No.: 13/360,960

(22) Filed: Jan. 30, 2012

(30) Foreign Application Priority Data
Mar. 4, 2011 (JP) 2011-47624

(51) Int. Cl. G06F 3/12

(52) U.S. Cl. 358/1.13

(57) ABSTRACT

A printing apparatus includes a platen glass, a read part, a print part, a sheet receiving part, an important information detection unit to detect whether important information is included in the original document read by the read part, a paper existence detection unit to detect at least one of whether the original document exists on the platen glass and whether the output sheet exists on the sheet receiving part, and a notifying part to notify misplacement of the original document or forgetting to take the output sheet if the important information detection unit detects that the important information is included in the read original document and the paper existence detection unit detects that the original document or the output sheet exists.

### CROSS-REFERENCE TO RELATED APPLICATION

This application is based upon and claims the benefit of priority from the prior Japanese Patent Application No. 2011-47624 filed on Mar. 4, 2011, the entire contents of which are incorporated herein by reference.

### FIELD

Embodiments described herein relate generally to a printing apparatus to print a document.

### BACKGROUND

There is a technique that detects forgetting to take an original document after the original document has been read in a multifunction peripheral (MFP) including a scanner and notifies users that they have forgotten to take the document. However, if forgetting to take a document is carelessly notified in an office, an unpleasant feeling may be given to surrounding persons. Besides, according to circumstances, there is a case where active notification is not necessary.

### DESCRIPTION OF THE DRAWINGS

FIG. 1 is a view showing the outline of an MFP in an embodiment.

FIG. 2 is a view showing a scanner in the embodiment.

FIG. 3 is a block diagram showing a main structure of the MFP.

FIG. 4 is an explanatory view of an important information file in the embodiment.

FIG. 5 is an explanatory view of a user file in the embodiment.

FIG. 6 is an explanatory view of a log file in the embodiment.

FIG. 7 is a flowchart of a login job in the embodiment.

FIG. 8 is a flowchart of a print job in the embodiment.

FIG. 9 is a flowchart of the print job.

### DETAILED DESCRIPTION

According to an embodiment, a printing apparatus includes a platen glass on which an original document is placed. An openable and closable document pressing unit configured to press the original document placed on the platen glass. A read part to read the original document on the platen glass. A print part to print the read document on a sheet. A sheet receiving part to receive the printed output sheet. An important information detection unit configured to detect whether important information is included in the original document read by the read part. A paper existence detection unit configured to detect at least one of whether the original document exists on the platen glass and whether the output sheet exists on the sheet receiving part. A notifying part to notify of misplacement of the original document or forgetting to take the output sheet if the important information detection unit detects that the important information is included in the read original document and the paper existence detection unit detects that the original document or the output sheet exists.

Hereinafter, an embodiment will be described with reference to the drawings. In this embodiment, a description will be made while using an MFP (Multi Function Peripheral) as an example of a printing apparatus.

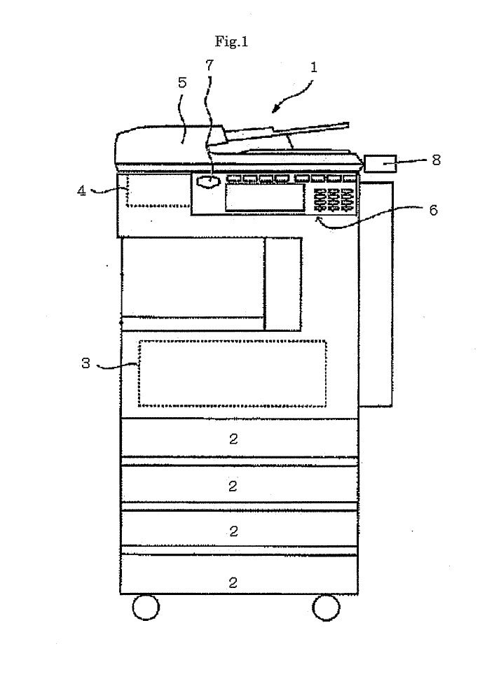

FIG. 1 is a front view showing the outline of an MFP, the MFP 1 includes plural paper feed cassettes 2, and the respective paper feed cassettes 2 contain plural sheets. The plural sheets contained in the respective paper feed cassettes 2 pass through a sheet conveyance path and are supplied to an image forming part 3. The image forming part 3 forms a developer image on the sheet based on image data. The image data includes, for example, image data transmitted from an external equipment to the MFP 1, and image data generated by a reading operation of a scanner 4.

The scanner 4 scans an image of a sheet original document and a book original document and generates image data. FIG. 1 shows a part of the scanner 4. An ADF (Auto Document Feeder) 5 for automatically feeding original documents is provided above the scanner 4.

An operation and display part 6 for inputting various information to the MFP 1 is provided at an upper part of the MFP 1. The operation and display part 6 includes, for example, a button switch and a liquid crystal panel. Besides, the MFP 1 includes a notifying part 7 which is provided on, for example, the operation and display part 6. Further, the MFP 1 includes a card reader 8.

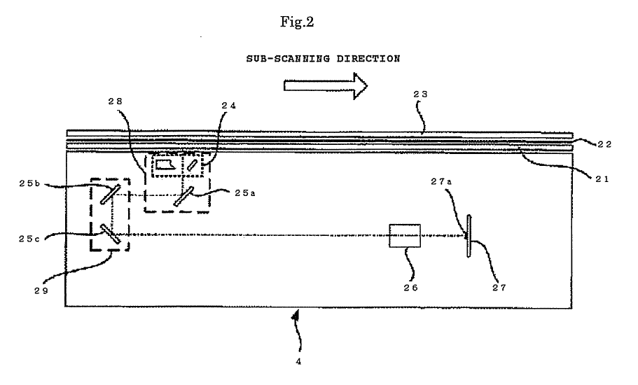

The structure of the scanner 4 will be described with reference to FIG. 2. FIG. 2 is a sectional view of the scanner 4 along a sub-scanning direction.

An original document 22 is placed on an upper surface of a platen glass 21, and the read surface of the original document 22 faces the upper surface of the platen glass 21. A platen cover 23 rotates with respect to a main body of the scanner 4, and opens the upper surface of the platen glass 21 or closes the upper surface of the platen glass 21. When the platen cover 23 is closed, the original document 22 is pressed to the platen glass 21. The platen cover 23 constitutes a part of the ADF 5.

An illumination unit 24 irradiates an illumination light to the original document 22. The illumination unit 24 extends in a direction (main scanning direction) perpendicular to the paper surface of FIG. 2, and the illumination unit 24 irradiates the linear illumination light extending in the longitudinal direction of the illumination unit 24.

The illumination light of the illumination unit 24 is reflected by the original document 22. The reflected light from the original document 22 is reflected by folding mirrors 25a, 25b and 25c and is directed to an imaging lens 26. The imaging lens 26 condenses the light from the folding mirror 25c, and forms an image on an image sensor 27. The image sensor 27 includes plural light-receiving elements 27a arranged in the direction perpendicular to the paper surface of FIG. 2. The plural light-receiving elements 27a are arranged correspondingly to the linear illumination light, and receive the linear illumination light. The respective light-receiving elements 27a output electric signals corresponding to the amount of incident light by photoelectric conversion. For example, a CCD sensor can be used as the image sensor 27.

The reflected light from the original document 22 is incident on the plural light-receiving elements 27a, so that, in the original document 22, an image area of one line extending in the main scanning direction can be read.

A first carriage 28 supports the illumination unit 24 and the folding mirror 25a, and can move in the sub-scanning direction. A second carriage 29 supports the folding mirrors 25b and 25c, and can move in the sub-scanning direction. The first carriage 28 and the second carriage 29 move relative to each other in the sub-scanning direction, and maintain an optical path length from a surface (a reflecting surface of the illumination light) of the original document 22 to an imaging surface of the image sensor 27 to be constant.

The first carriage 28 and the second carriage 29 move, so that the illumination light from the illumination unit 24 can be scanned in the sub-scanning direction. While the first carriage 28 and the second carriage 29 are moved in the sub-scanning direction, the image area of one line extending in the main scanning direction in the original document 22 can be sequentially read.

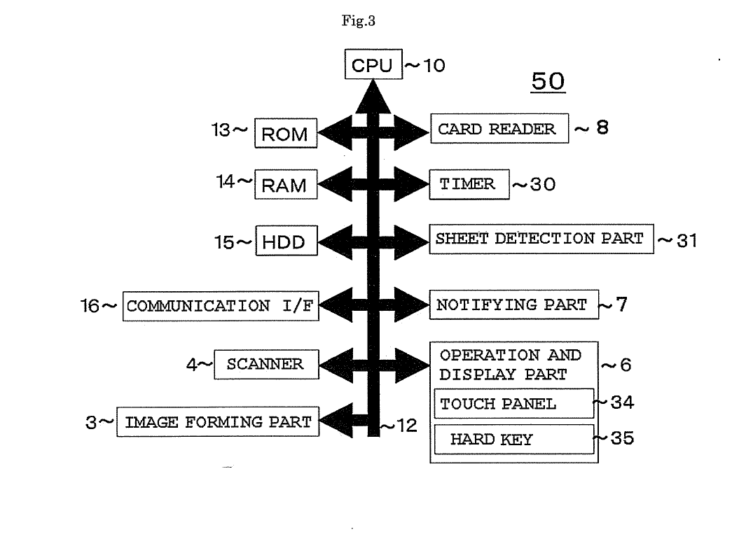

FIG. 3 is a block diagram showing the structure of the MFP 1 used in the description of the embodiment. The MFP 1 includes a CPU 10 as an arithmetic device and control device. The CPU 10 is connected with a ROM (Read Only Memory) 13, a RAM (Random Access Memory) 14, a HDD (Hard Disk Drive) 15, a communication interface (communication I/F) 16, the scanner 4, the image forming part 3, the card reader 8, a timer 30, a sheet detection part 31, the notifying part 7, and the operation and display part 6 through a bus line 12 such as an address bus or a data bus.

The ROM 13 stores a program which is read by the CPU 10 and causes the CPU 10 to perform various functions, and fixed data as an object of data processing of the program. The RAM 14 dynamically forms various memory areas such as a work area which becomes workspace for the data processing of the program.

The RAM 14 includes an area to store an important flag in the embodiment. The important flag is used to manage whether or not a document read by the scanner 4 is an important document. If the important flag is set to “1”, the document read by the scanner is the important document. If the important flag is set to “0”, the document read by the scanner is not the important document.

The RAM 14 includes an area to store an opening and closing flag in the embodiment. The opening and closing flag is used to determine whether the ADF 5 is opened and closed before printing and an original document is placed on the platen glass 21. If the opening and closing flag is “0”, this represents that the original document is not placed on the platen glass 21 and the ADF 5 is used. If the opening and closing flag is “1”, this represents that the original document is placed on the platen glass 21. The opening and closing flag is, for example “0” as a default.

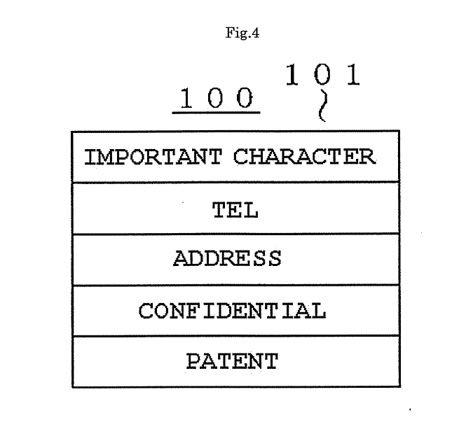

The HDD 15 stores, for example, data and programs. In this embodiment, the HDD stores OCR (OPTICAL CHARACTER READER) software. Besides, as shown'in FIG. 4, the HDD 15 stores an important information file 100. The important information file 100 is used to detect whether important information is included in the original document read by the scanner 4. The important information file 100 includes an important character area 101 to store a character having a high possibility of important information. The character having the high possibility of important information is a character such as, for example, “telephone number”, “TEL”, “confidential”, “address” or “patent”. The document including these characters has a high possibility that the document is a document for internal consumption only, is a document relating to privacy of customers or company members, or is a document including company secret.

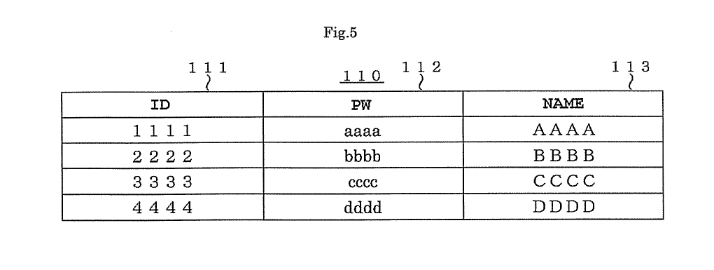

Besides, as shown in FIG. 5, the HDD 15 stores a user file 110. The user file includes an ID (IDENTIFICATION) area 111, a PW (PASSWORD) area 112 corresponding to the ID area 111 and a name area 113. The ID area 111 stores a user ID when each user uses the MFP 1. The PW area 112 stores a password corresponding to the user ID. The name area 113 stores a user name of the user corresponding to the user ID. For example, the user uses a card storing the ID and the password, and inputs the information when the MFP 1 is used. The user inputs the information (ID, password) stored in the card to the MFP 1. When the inputted information coincides with the user ID and the password in the user file 110, a login process to enable the operation of the MFP 1 is performed to enable printing.

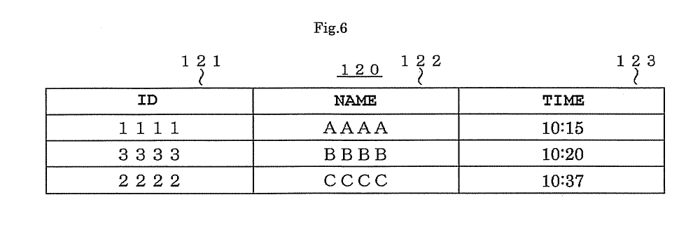

Besides, as shown in FIG. 6, the HDD 15 stores a log file 120. The log file 120 includes an ID area 121, a name area 122 corresponding to the ID area 121, and a time area 123. The ID area 121 stores IDs in the order of logging in the MFP 1. The name area 122 stores user names corresponding to the IDs. Besides, the time area 123 stores login times.

The communication I/F 16 is an interface to communicate with the outside. For example, a LAN port for connecting to a LAN (Local Area Network), and a LAN cable connected to the LAN port are conceivable.

The scanner 4 reads an original document set on the platen glass 21 or the ADF 5. The ADF 5 is provided on an upper portion of the platen glass 21, and is opened and closed by using a shaft. The ADF 5 has a function to press the original document placed on the platen glass 21. The ADF 5 feeds the original document to an original document reading position, and when the scanner 4 reads the original document, the original document is discharged to a discharge part. On the other hand, an original document manually placed on the platen glass 21 is pressed to the platen glass 21 by the ADF 5. Even if the scanner 4 completes reading of the original document, unless the operator opens the ADF 5 and takes out the original document, the original document remains on the platen glass 21.

For example, in order to perform image formation by a well-known electrophotographic system, the image forming part 3 includes an image scanning part including a laser element, an image forming part including a photoconductive drum on which an image (electrostatic latent image) is formed by laser light, a charging part to charge the surface of the photoconductive drum, a developing part to develop the electrostatic latent image formed on the photoconductive drum with toner, a transfer part to transfer a developed toner image to a sheet, and a fixing part to fix the toner image transferred to the sheet. The image forming part 3 prints data received from the scanner 4 or the communication I/F 16 in accordance with the instruction of the CPU 10. When printing is performed, the sheet is conveyed to a discharge port through a conveyance path, and the sheet (output sheet) on which the image is fixed is discharged to a paper discharge tray (sheet receiving part).

In the above example, although black and white printing is described, if color printing is performed, for example, four sets (yellow, magenta, cyan, black) of image forming parts, charging parts, developing parts, and transfer parts are required. Toner images developed with the respective colors are transferred to an intermediate transfer belt, and are further transferred to a sheet.

The card reader 8 reads the card storing the ID and password for logging in the MFP 1. The card reader 8 outputs the read ID and password to the RAM 14. The card reader 8 can be a non-contact IC card reader to read a non-contact IC card, or can be a magnetic card reader.

The timer 30 counts the present time. The timer 30 outputs the present time in accordance with the instruction of the CPU 10.

The sheet detection part 31 detects forgetting to take or misplacement of the output sheet or the original document, and outputs the result to the CPU 10. For example, an opening and closing detection sensor to detect the opening and closing of the ADF 5 is provided in the vicinity of the platen glass 21. A detection signal is outputted to the CPU 10 according to the opening and closing of the ADF 5 before an original document is placed or after a sheet is printed. The CPU 10 determines the presence or absence of the original document on the platen glass 21 based on the detection signal from the opening and closing detection sensor. Besides, for example, a light shielding sensor can be provided at the paper discharge tray to receive the output sheet subjected to the printing. Whether the output sheet exists on the tray is detected based on whether the printed sheet shields the light shielding sensor.

Based on the detection result of the sheet detection part 31, if the original document sheet is placed on the platen glass 21 or if the printed output sheet is placed on the paper discharged tray, the notifying part 7 notifies the operator of the misplacement or forgetting to take the original document or the output sheet by using a sound (or a voice) or light in accordance with the instruction from the CPU 10. Besides, for example, if the ID or password inputted from the card reader 8 is not correct, the notifying part 7 notifies that effect (error).

The operation and display part 6 includes a touch panel 34 and a hard key 35. The touch panel 34 displays various instruction items such as, for example, a sheet size, number of copies, and print density setting. A specified item is inputted by touching the displayed item of the touch panel. Besides, as the display of the touch panel, a screen for inputting the ID and password is displayed before login, and when login is completed, the screen is changed to a screen in which information relating to printing is inputted. The hard key 35 includes, for example, a numerical keypad, a reset key, a start key, an authentication key and the like. When the authentication key is pressed during logout, a logout process of returning the state to one before login is performed.

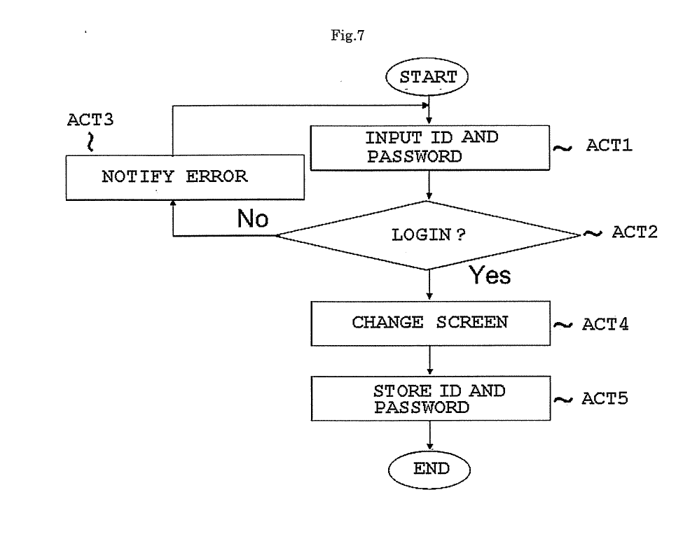

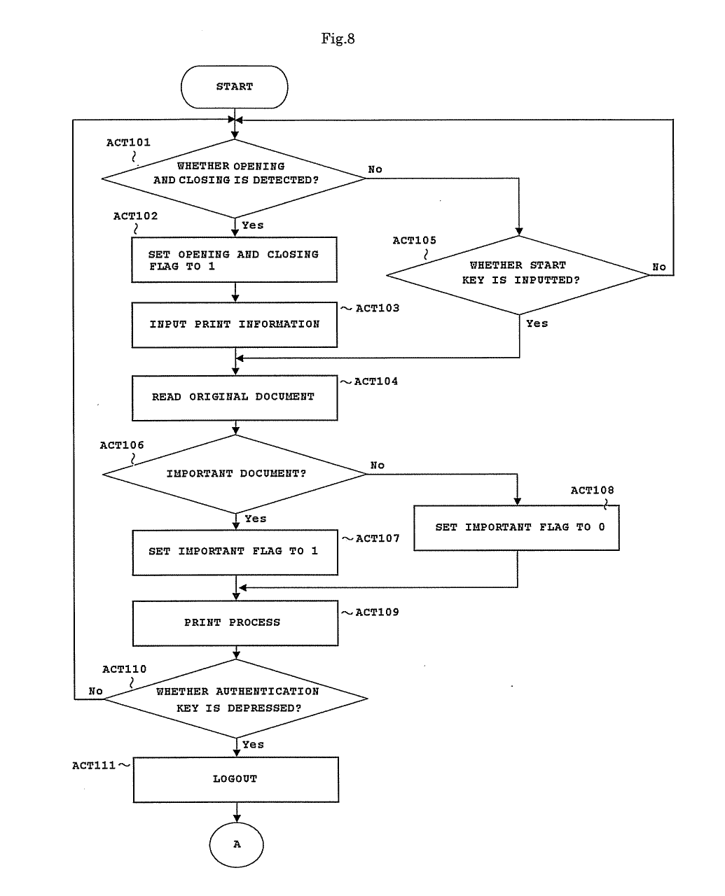

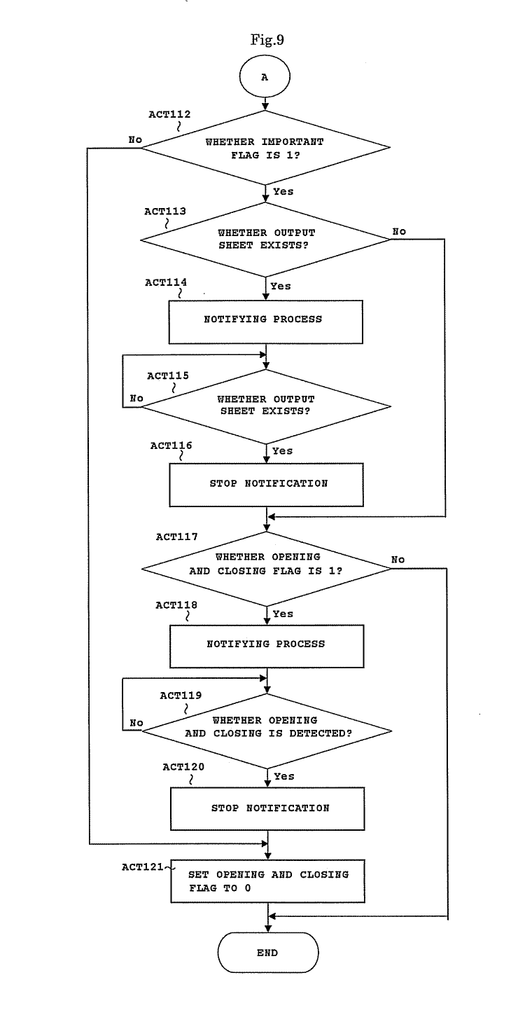

In the MFP 1 including the hardware structure and the file structure as stated above, the CPU 10 performs a login job shown in FIG. 7 and a series of print jobs shown in FIG. 8 and FIG. 9 based on a previously set program.

First, the login job shown in FIG. 7 will be described. The operation and display part 6 of the MFP 1 displays the input screen for the ID and password in the initial state. At Act 1, the card reader 8 receives input of the ID and password from, for example, the card of the operator. Next, the CPU 10 performs a login process (Act 2). Specifically, the CPU 10 searches the ID area 111 of the user file 110 stored in the HDD 15 and shown in FIG. 5 while using the inputted ID as a key. If an ID coincident with the inputted ID exists in the ID area 111, a determination is made on whether the password stored in the corresponding PW area 112 coincides with the inputted password. If the inputted ID or the password does not coincide (No at Act 2), the notifying part 7 notifies the error (Act 3), and a return is made to Act 1. The operator again attempts to log in.

On the other hand, if the inputted ID exists in the ID area 111, and the inputted password coincides with the password stored in the corresponding PW area 112 (Yes at Act 2), the CPU 10 changes the operation and display part 6 into the state where information relating to printing is received (Act S4).

Besides, the ID inputted at Act 1 and the user name corresponding to the ID are acquired from the ID area 111 and the name area 113 of the user file 110, and are stored in the ID area 121 and the name area 122 of the log file 120 shown in FIG. 6. In addition, the time (login time) when the ID and the user name are stored in the log file 120 is acquired from the timer 30 and is stored in the time area 123 (Act 5).

Next, the print job shown in FIG. 8 and FIG. 9 will be described.

As shown in FIG. 8, at Act 101, the sheet detection part 31 detects whether the ADF 5 is opened and an original document is placed on the platen glass 21.

If the opening and closing sensor of the sheet detection part 31 does not detect the opening of the ADF 5 (No at Act 101), detection is made whether a key signal of the start key of the operation and display part 6 is inputted (Act 105). If the key signal of the start key is inputted (Yes at Act 105), reading of the original document is performed at Act 104. In this case, the scanning reading unit of the scanner 4 reads the original document fed from the ADF 5. In this case, the opening and closing flag of the RAM 14 is not changed. Incidentally, as stated above, the touch panel 34 of the operation and display part 6 is operated before the input of the key signal of the start key, and the information relating to the printing is inputted. On the other hand, if the key signal of the start key is not inputted (No at Act 105), the process returns to Act 101.

On the other hand, if the opening and closing sensor of the sheet detection part 31 detects the opening of the ADF 5 (Yes at Act 101), the opening and closing flag of the RAM 14 is changed to “1” (S102)

Next, the touch panel 34 of the operation and display part 6 is operated, and the information relating to the printing is inputted. Thereafter, the key signal of the start key is inputted (Act 103).

When the CPU 10 detects the key signal of the start key of the hard key 35, the CPU reads the original document placed on the platen glass 21 by the scanning reading unit of the scanner 4 (Act 104).

Next, detection is made whether important information exists in the read original document (Act 106). Specifically, the read original document, is temporarily stored as image information in the RAM 14. OCR software stored in the HDD 15 is used and character information is extracted from the image information stored in the RAM 14. Next, retrieval is made whether the character (important information) stored in the important character area 101 of the important information file 100 shown in FIG. 4 is included in the extracted character information (important information detection unit).

If detection is made that the character stored in the important character area 101 is included in the extracted character (Yes at Act 106), the important flag of the RAM 14 is set to “1” (Act 107). On the other hand, if detection is not made that the character stored in the important character area 101 is included in the extracted character (No at Act 106), the important flag of the RAM 14 is set to “0” (Act 108). In this case, if the important flag is set to “0” as a default, the operation of Act 108 is not required.

Next, an image process is performed on the original document (image data) temporarily stored in the RAM 14 if necessary, and the image forming part 3 performs a print process. If the print process is completed, the printed output sheet is discharged to the paper discharge tray (Act 109).

When the print process is completed, detection is made whether a key signal of the authentication key for logout is inputted (Act 110). If the key signal of the authentication key is inputted (Yes at Act 110), the screen of the touch panel 34 of the operation and display part 6 is changed, and the logout process is performed (Act 111). On the other hand, if the key signal of the authentication key is not inputted (No at Act 110), the process returns to Act 101. The CPU 10 repeats the process from Act 101 to Act 110 as described above.

Next, as shown in FIG. 9, the CPU 10 detects whether “1” is stored in the important flag of the RAM 14 (Act 112). At this time, if the CPU 10 detects that “1” is not stored (No at Act 112), “0” is stored in the opening and closing flag of the RAM 14 (Act 121), and the process is ended. Even if the original document is placed on the platen glass 21, since the important information is not included in the original document, there is no problem even if misplacement of or forgetting to take the original document or the output sheet occurs, and the detection of the original document or the output sheet is omitted.

On the other hand, if the CPU 10 detects that “1” is stored in the important flag of the RAM 14 (Yes at Act 112), the sheet detection part 31 detects whether the output sheet exists on the paper discharge tray (Act 113). For example, a sensor provided at the paper discharge tray detects the output sheet. Here, if the sensor does not detect that the output sheet exists on the paper discharge tray (No at Act 113), a determination is made that the output sheet is taken out, and detection is made whether “1” is stored in the opening and closing flag (Act 117). (At least one of the process of Act 117 and the process of Act 113 corresponds to a paper existence detection unit.)

On the other hand, if the sheet detection part 31 detects that the output sheet exists on the paper discharge tray (Yes at Act 113), the CPU 10 determines whether the output sheet is an important document and forgetting to take the sheet (original or outputted sheet) has occurred. Then, the CPU activates the notifying part 7 to notify the operator that the output sheet exists on the paper discharge tray (Act 114). This is notified in such a way that for example, an alarm sound is generated, or a sound message about forgetting to take the original and/or outputted sheet is generated, or a specified lamp of the operation and display part is flickered.

Besides, the notification can be performed such that the timer counts the time after logout, and if a determination is made that forgetting to take occurs after a specified time, the notification is performed by light, and then, the forgetting to take continues even after a specified time elapses, the notification is performed by sound.

When the notifying part 7 is activated, the sheet detection part 31 again detects whether the output sheet exists on the paper discharge tray (Act 115). If the sheet detection part 31 detects that the output sheet exists on the paper discharge tray (Yes at Act 115), a determination is made that the forgetting to take the output sheet is not solved, and return is again made to Act 115. On the other hand, if the sheet detection part 31 does not detect that the output sheet exists on the paper discharge tray (No at Act 115), the CPU 10 stops the notifying part 7 (Act 116).

Next, detection is made whether “1” is stored in the opening and closing flag of the RAM 14 (Act 117).

When detection is made that “1” is stored in the opening and closing flag of the RAM 14 (Yes at Act 117), the CPU 10 determines that the original document is placed on the platen glass, and determines that the original document is an important document. Then, the CPU 10 actuates the notifying part 7 to notify the operator that the original document exists on the platen glass 21 (Act 118).

Next, in order to determine the presence of the original document, the sheet detection part 31 detects whether the ADF 5 is opened (Act 119). When the sheet detection part does not detect opening and closing (No at Act 119), the CPU 10 determines that the misplacement of the original document is not solved, and returns to Act 119. Then, the opening and closing detection is again performed.

On the other hand, if the sheet detection part 31 detects that the ADF 5 is opened (Yes at Act 119), the CPU 10 determines that the original document is taken out and stops the operation of the notifying part (Act 120). Then, the CPU stores “0” in the opening and closing flag of the RAM 14 (Act 121), and ends the series of processes. Incidentally, when detection is made that the opening and closing flag is not “1” (that is, “0”) at Act 117 (No at Act 117), the CPU 10 determines that the ADF 5 is used and the original document is sent, and ends the process.

In the embodiment, if a document having a high possibility that the document is an important document is misplaced or forgotten to be taken, the misplacement or forgetting to take can be notified. For example, in an office where persons using the MFP are limited to a certain degree, there is also a case where even if the misplacement or forgetting to take the original document and/or the outputted sheet occurs, the document may be taken afterward, and with respect to all documents, the misplacement or forgetting to take is not required to be notified. If the misplacement of or forgetting to take the original document or the output sheet is notified carelessly, the forgetting to take the document or the misplacement thereof is known to acquaintances, and the image of the forgetting person becomes worse. However, there is also a document which should not be misplaced or forgotten to be taken, such as a document containing customer's addresses or a document which has a high confidential level and should not be seen except for a specific person. If the important document as stated above is misplaced or forgotten to be taken, this is notified so that the misplacement of or forgetting to take the document can be suitably notified.

In the embodiment, although the password and the ID are inputted and login is performed, a modification can be made such that the input of the password is omitted, and if a correct ID is inputted, login can be performed. A department or section code or the like is conceivable as the ID to be inputted here.

Besides, in the embodiment, the important flag is first checked, and then, detection is made whether the original document or the output sheet is placed. However, after the presence or absence of the original document or the output sheet on the platen glass 21 or the paper discharge tray is detected, the important flag can be checked.

In the embodiment, although the identification of the important document is performed by using a character, the identification of the important document can be performed by using a symbol or a figure.

In the embodiment, although the notification is performed by sound or light, the notification can be made to an external terminal through a wired or wireless network. For example, a mail address area 114 is provided in the user file 110, and a mail address corresponding to the user ID is stored in this area. Especially, a mail address of a cellular phone is preferable. When misplacement or forgetting to take is detected, a mail indicating that there is misplacement of or forgetting to take an original document or an output sheet is transmitted to this address.

In the embodiment, although forgetting to take the original document and the output sheet on the platen glass 21 and the paper discharge tray is detected, one of them may be detected. By notifying the operator of the forgetting to take the original document, the operator can be motivated to check the platen glass 21 and the paper discharge tray.

In the embodiment, although the important information file 100 is stored in the HDD 15, the important information file 100 can be stored in an external apparatus, for example, a server (storage part). In this case, in the process of detecting whether important information exists in the read original document at Act 106 of FIG. 8, for example, important character information is obtained from the important information file stored in the external apparatus through the communication I/F 16. By doing so, for example, individual setting of an important character unique to a specific office using the MFP can be easily performed. Besides, a modification can be made such that read image information is transmitted to an external server through the communication I/F 16, the server determines whether important information is included in the image information, and the result is received.

Although exemplary embodiments of the invention have been described, these embodiments have been presented by way of example only, and are not intended to limit the scope of the invention. Indeed, the novel embodiments maybe embodied in a variety of other forms, and various omissions, substitutions and changes may be made without departing from the gist of the invention. The embodiments and modifications thereof are included within the scope and gist of the invention, and are included within the scope of the invention recited in claims and their equivalents.

What is claimed is:

1. A printing apparatus comprising:
a platen glass on which an original document is placed;
a read part to read the original document on the platen glass;
a print part to print the read document on a sheet;
a sheet receiving part to receive the printed output sheet;
an important information detection unit configured to detect whether important information is included in the original document read by the read part;
a paper existence detection unit configured to detect at least one of whether the original document exists on the platen glass and whether the output sheet exists on the sheet receiving part; and
a notifying part to notify misplacement of the original document or forgetting to take the output sheet if the important information detection unit detects that the important information is included in the read original document and the paper existence detection unit detects that the original document or the output sheet exists.

2. The apparatus of claim 1, further comprising a storage part to store character information relating to the important information, wherein the important information detection unit detects whether the character information stored in the storage part is included in the original document read by the read part.

3. The apparatus of claim 1, further comprising a communication unit configured to communicate with an external storage part to store character information relating to the important information, wherein the important information detection unit communicates with the storage part through the communication unit, and detects whether the character information is included in the read original document.

4. The apparatus of any one of claims 1, wherein after the important information detection unit detects that the important information is included in the original document read by the read part, the paper existence detection unit detects whether the original document exists on the platen glass.

5. The apparatus of any one of claims 1, wherein after the important information detection unit detects that the important information is included in the original document read by the read part, the paper existence detection unit detects whether the output sheet exists on the sheet receiving part.

6. A method of preventing removal of document from being forgotten, comprising:
reading an original document on a platen glass;
printing a read document on a sheet;
discharging the printed output sheet to a sheet receiving part;
detecting whether important information is included in the read original document;
detecting at least one of whether the original document exists on the platen glass and whether the output sheet exists on the sheet receiving part; and
notifying misplacement of the original document or forgetting to take the output sheet if detection is made that the important information is included in the read original document and detection is made that the original document or the output sheet exists.

7. The method of claim 6, wherein whether the important information is included in the original document is detected based on whether character information stored in a storage part and relating to the important information is included in the read original document.

8. A program, stored on a non-transitory computer-readable medium, for causing a computer to realize a function for controlling a printing apparatus including a platen glass, and an openable and closable document pressing part to press an original document placed on the platen glass, the function comprising:
reading the original document on the platen glass;
printing the read document;
discharging a printed output sheet to a sheet receiving part;
detecting whether important information is included in the read original document;
detecting at least one of whether the original document exists on the platen glass and whether the output sheet exists on the sheet receiving part; and
notifying misplacement of the original document or forgetting to take the output sheet if detection is made that the important information is included in the read original document and detection is made that the original document or the output sheet exists.
